(19) United States
(12) Patent Application Publication
(10) Pub. No.: US 2004/0228566 A1
(43) Pub. Date: Nov. 18, 2004

(54) Fibre-optic cable detection apparatus and method

(76) Inventors: Andrew Biggerstaff Lewis, Bristol (GB); Stuart John Russell, Southampton (GB); John Phillip Dakin, Romsey (GB)

Correspondence Address: BAKER & HOSTETLER LLP, Suite 1100, Washington Square, 1050 Connecticut Avenue, N.W., WASHINGTON, DC, 20036, US

(21) Appl. No.: 10/439,336

(22) Filed: May 16, 2003

(51) Int. Cl. G02B 6/00

(52) U.S. Cl. 385/11

(57) ABSTRACT

An apparatus for detecting and/or locating a fibre-optic cable (170) by applying a magnetic field with a component parallel to the cable (170) and detecting the cumulative rotation of polarisation of a polarised beam passing through the magnetic field multiple times. The beam is preferably input into the cable (170) multiple times, with the same polarisation and amplitude each cycle. In this case, a regeneration stage (800) is provided to recycle the beam with the correct amplitude and polarisation. A method of detecting a fibre-optic cable (170) is also disclosed.

### FIELD OF THE INVENTION

The present invention relates to an apparatus for detecting the position of fibre-optic cables and a method for carrying out the same.

### BACKGROUND OF THE INVENTION

There are many known methods of identification of underground objects. Many of these make use of a magnetic field generated by passage of an alternating current through the object, or the current induced by a magnetic field applied to the object.

Fibre-optic cables may be protected by a metallic sheath. However, use of such a metallic sheath can cause damage to the fibres it is intended to protect, for example where a lightening strike occurs causing very high currents to pass along the cable.

Therefore, it is desirable to protect the cables by using a non-metallic sheath, such as Kevlar™, in order to avoid such damage. Additionally, non-metallic sheaths are cheaper and the cost of ownership is lower. However, use of such non-metallic materials means that it is not possible by conventional electromagnectic techniques.

Because many known detectors make use of metallic elements in the cable to be identified and located, they are not suitable to detect non-metallic cables. U.S. Pat. No. 6,480,635 (the entire contents of which are incorporated herein by reference) discloses the use of the so-called Faraday effect to detect fibre-optic cables underground. The Faraday effect causes a rotation in the polarisation of linearly polarised light when a magnetic field is applied in the direction of propagation of the light. If a linearly polarised beam of light is applied to one end of a fibre-optic cable to be located and an antenna is placed in proximity to the fibre-optic cable, inducing a rotation of the polarisation of the light in the cable, this rotation can be determined at the other end of the cable by measuring the polarisation state of the light as it exits the fibre.

However, the Faraday effect is very weak, and the magnetic field required to be applied to obtain a noticeable rotation of polarisation state is high. The application of the Faraday effect has thus far been of limited use and success.

It is an object of the invention to provide an improved optical cable detection system.

### SUMMARY OF THE INVENTION

An aspect of the invention provides a method of detecting or locating a fibre-optic cable by applying a magnetic field to the cable and detecting the cumulative rotation of polarization of a beam of polarized light passed through the cable multiple times.

In an embodiment, the beam passes along the cable in both a first or outward and second or return direction. It may only pass along the cable in the outward direction with the beam returning, to pass in the outward direction along the fibre again, via a different route not within the cable. In an alternative embodiment the beam only passes through the cable in the return direction, the outward path being via a different route, not within the cable. In an embodiment where the beam travels along the cable in both directions, it may pass along the same fibre in both directions, or a different fibre in each direction.

Where the beam travels along the same fibre in both directions, a polarization conjugate mirror may be provided to reflect the beam, such that, at each point on the fibre, the beam on its return path is the polarization conjugate of the beam on its outward path.

Any arrangement where the beam passes through a magnetic field to have multiple rotations of the polarization of the beam, which are then detected may be used in the present invention.

An embodiment of the invention provides an apparatus, for use in the detection and/or location of a fibre-optic cable, comprising a generator and a detector. The generator generates light, which is polarised and can be linearly polarised or can have any other predetermined polarisation. The generated light may be a pulse, or may be a continuous wave. A method is provided as a further embodiment, of detecting cables where a rotation of the polarization has been imparted by a magnetic field as the beam passes though the field multiple times.

In another embodiment, the apparatus sends a polarized beam out along a first cable fibre and receives the beam back from a second cable fibre, which may or may not be in the same cable as the first fibre. Once again, however, the polarization of the received beam is detected for cumulative rotation of the polarization whilst in the fibre on outward and return parts of the beam's path.

In one embodiment, the frequency of the magnetic field applied to the fibre is such that it generates a standing wave, as observed by a photon traversing the cable to be detected/located.

More than one polarisation state may be generated, either concurrently in a single beam or successively in successive beams, and these polarisation states may be orthogonal. More than one frequency of light may be generated, again either concurrently or successively to be input into a cable to be detected or located.

For the avoidance of doubt, the cable or cables do not comprise part of embodiments of the invention, but are used with the invention, and located/detected by embodiments of the invention.

In an embodiment of the invention, the detector detects the polarisation state of the light from the generator. The detector may detect the absolute polarisation of the light and the difference between two orthogonal polarisations. The detector may detect the intensity of two orthogonal linear states. The detector may therefore detect the polarisation state of a beam, by detecting the projection of the polarisation onto two orthogonal axes.

In embodiments of the invention, the “same” beam of light, i.e. a beam with the same physical attributes as a previous beam, is input into the cable more than once. A loop or reflector may be provided to return the beam into the cable. The polarisation state of this re-entered light in each cycle is preferably the same as the polarisation state when the beam first entered the cable. A regeneration stage or beam amplifier may be provided in order to ensure that successive beams input into the cable are of approximately equal intensity.

In an embodiment of the present invention, the pulse is input into a first fibre in the cable a plurality of times and on each pass along the first fibre, a Faraday rotation is imparted by a magnetic field. In a further embodiment a Faraday rotation is also imparted as each pulse returns along a second fibre. In an embodiment, the outward and return paths are through the same fibre.

The detected cumulative rotation of polarisation may be read at every cycle and processed, or may only be processed after a predetermined number of cycles of the beam.

The invention may be used in a system comprising a source, a detector and an antenna, which is located remote from the source and detector and can irradiate the cable to be detected with a magnetic field with a component substantially parallel to the cable to be detected.

The detector and beam input may both be at one end of a fibre cable to be located/detected. Alternatively, the detector and beam input may be at opposite ends of the cable. The light generator or source is conveniently placed at the same end of the cable as the beam input.

The beam may be a pulse, and may be of varying a duration equal to the time taken for a photon to pass from the first end of the cable to the second end. Alternatively, the duration may be shorter or longer than this.

Embodiments of the invention can be used for locating an underground, or otherwise inaccessible fibre optic cable.

Using embodiments of the invention, the detector can indicate when an antenna irradiating the cable is in proximity to the cable. The intensity of the detected polarisation change increases as the distance between the antenna and cable reduces.

Although the terms fibre optic cable and cable fibre are used in the description and claims, it will be appreciated that other optical communication or transmission media may also be used.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Embodiments of the invention will now be described, purely by way of example, with reference to the accompanying drawings, in which:

FIG. 1 is a diagram of an apparatus according to a first embodiment of the invention;

FIG. 2 is a flow chart showing the method of operation of the apparatus according to the first embodiment of the invention;

FIG. 3 is a flow chart showing the operation of a generation stage according to the first embodiment of the present invention;

FIG. 4 is a flow chart showing the operation of a detection stage according to the first embodiment of the present invention;

FIG. 5 is a graph showing the detection response of a detector of the first embodiment of the invention;

FIG. 6 shows an antenna, which can be used with the first embodiment of the invention;

FIG. 7 is a flow chart showing the steps occurring in the fibre optic cable according to the first embodiment of the present invention;

FIG. 8 is a diagram of an apparatus according to a second embodiment of the present invention;

FIG. 9 is a flow chart showing the operation of the apparatus according to the second embodiment;

FIG. 10 is a flow chart showing the operation of a regeneration stage according to the second embodiment of the present invention;

FIG. 11 is a flow diagram showing the processing steps for determining the state of polarisation to be applied to pulses in the second embodiment;

FIG. 12 is a Poincaré Sphere showing polarisation states in the second embodiment of the invention;

FIG. 13 is a diagram showing various parameters of the second embodiment of the invention;

FIG. 14 is a diagram showing a third embodiment of the present invention;

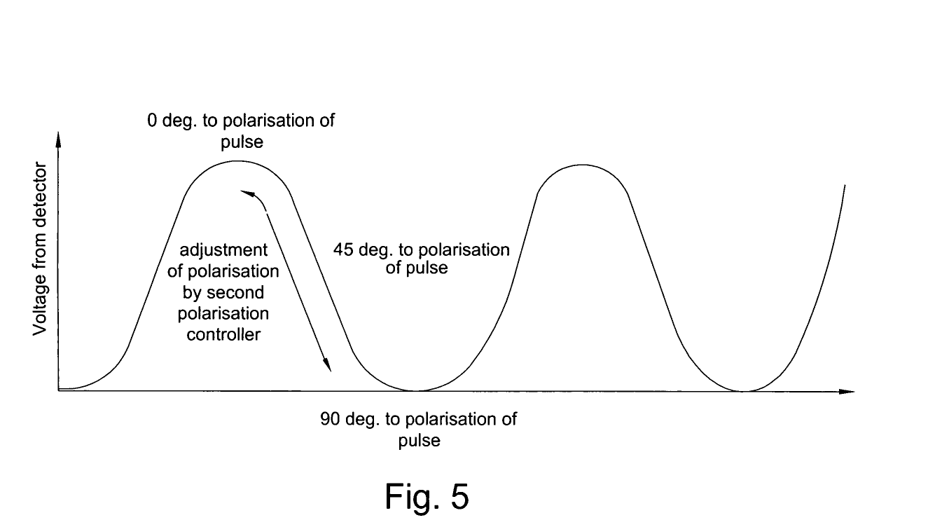

FIG. 5 is a diagram showing a regeneration stage of a fourth embodiment of the present invention;

FIG. 16 is a diagram showing a fifth embodiment of the present invention;

FIG. 17 is a diagram showing a sixth embodiment of the present invention; and

FIG. 18 is a flow diagram showing the operation of the sixth embodiment of the present invention.

### DETAILED DESCRIPTION

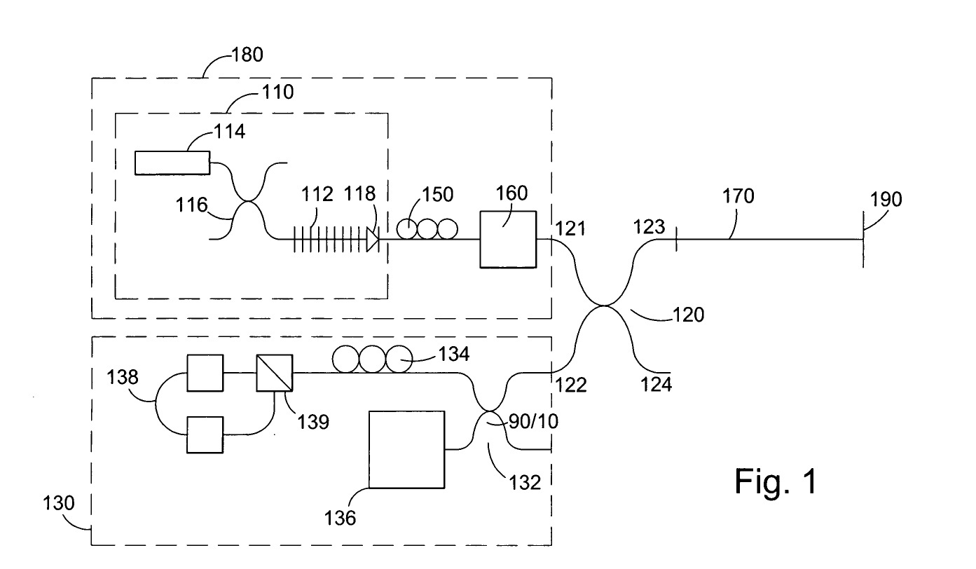

An apparatus according to a first embodiment of the present invention is shown in FIG. 1 and comprises a source 110, a first optical coupler 120 and a detection stage 130.

The source 110 is optically coupled to the optical coupler 120, and generates laser light, which is input into the first optical coupler 120. The detection stage 130 is also optically coupled to the first optical coupler 120 and receives light output from the first optical coupler 120.

The source 110 comprises a fibre Distributed Feedback (DFB) Laser 112, a pump 114, a Wavelength Division Multiplexer (WDM) 116 and an isolator 118. The pump 114 generates a beam which is then passed through the WDM 116 and into the DFB laser 112 before being output from the source 110. The isolator 118 prevents light from re-entering the source 110 which would cause lasing.

Any coherent source may alternatively be utilised, but a fibre DFB laser is preferred because a narrow line width is obtained. A narrow line width (30 kHz) reduces noise signals over large lengths of fibre (for example over many hundreds of kilometres).

A DFB laser is also advantageous because this means that the cable location system can be used on a live fibre, carrying communications traffic, as well as location information. In order to do this, the laser has a channel spacing of 25 GHz, as this is the current specification of a DWDM system.

The pump 114 is set at a wavelength of 975 nm.

Between the source 110 and the first optical coupler 120 are a polarisation controller 150, and a first Acousto-Optic Modulator (AOM) 160 arranged in series.

In the first embodiment, instead of using an output from the source 110, which is pulsed by the first AOM 160, the polarisation controller 150 and first AOM 160 may be omitted. If these are omitted, a continuous wave is obtained, which alternatively may be used in this embodiment.

The source 110, together with polarisation controller 150 and first AOM 160, comprise a generation stage 180.

The first optical coupler 120 comprises four ports 121, 122, 123, 124 arranged in two sets of two ports 121, 122 and 123, 124. Each port from the first set 121, 122 is coupled without bias to both ports from the second set 123, 124 and vice versa. The source 110 is connected to the first port 121.

Therefore, any light entering the first optical coupler 120 by the first port 121 is output to the third and fourth ports 123 and 124 equally, i.e. 50% exits via the third port 123 and 50% exits via the fourth port 124.

One of the second set ports 123, 124 of the optical coupler 120 is connected to a fibre to be located 170. The other port of the second set of ports 124 is blanked by index matching in order to reduce reflection. The second port of the first set 122 of the first optical coupler 120 is connected to the detection stage 130.

The detection stage 130 comprises a second optic coupler 132, which is the same as the first optical coupler 120 except that a bias is applied between each of the ports of the first set, and between each of the ports of the second set. The bias is 90/10, meaning that 90% of the light entering in one of the first set of ports of the second optical coupler 132 exits via the first port of the second set and the remaining 10% does so via the second port of the second set.

The second port 122 of the first optical coupler 120 is connected to one of the first set of ports of the second optical coupler 132.

A polarisation controller 134 and a polarimeter 136 are connected to respective ports of the second set of the second optical coupler 132. The polarisation controller 134 is connected to a Polarisation Division Multiplexer (PDM) 139, and a differential detector 138 is attached to both outputs of the PDM 139. The output from the differential detector 138 is sent to a processor, which is a computer, running processing software. Alternatively, the processor may be purely hardware implemented or purely software implemented or any combination thereof.

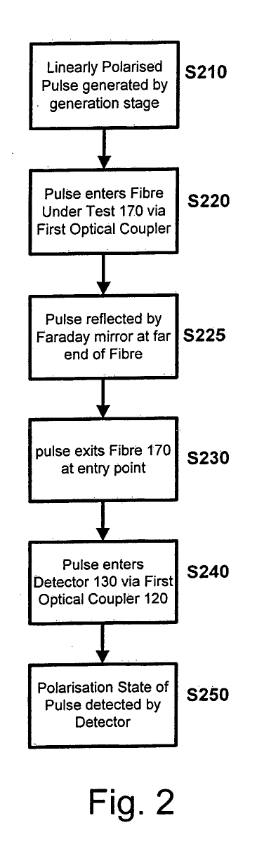

The light path of a pulse generated by the apparatus of the first embodiment of the invention will now be described with reference to FIGS. 2 to 6 of the drawings.

FIG. 2 shows a flow diagram of steps involved in the first embodiment of the invention.

At S210, the generation stage 180 generates a linearly polarised laser pulse. The Pulse enters fibre to be located 170 via the First Optical Coupler 120 at S220. The pulse exits the fibre to be located 170 at the same end that it entered at S230. The pulse then enters the detection stage 130 via the First Optical Coupler 120 at S240. The polarisation state of the pulse is then detected by the detection stage 130 at S250. Alternatively, a CW laser beam may be used.

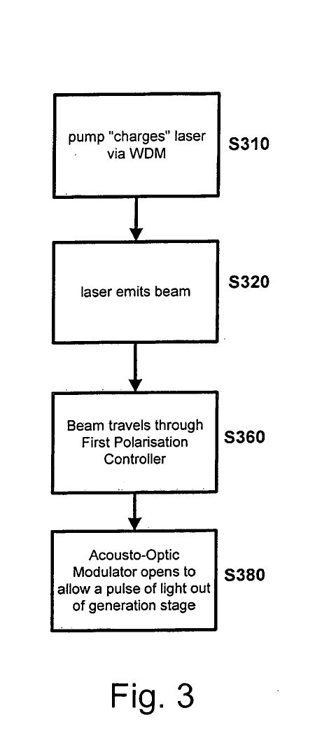

FIG. 3 shows the process of the generation stage 180 in detail. This is a narrow line-width source. The pump 114 is set at a wavelength of 975 nm and feeds the fibre DFB laser 112 via the WDM 116 at S310. The fibre DFB laser 112 then outputs the laser light from the source 110 at S320.

The light exiting the source 110 passes through a polarisation controller 150 at S360, and a first Acousto-Optic Modulator (AOM) 160 at S380, which opens and closes to allow pulses out of the generation stage 180.

The polarisation controller 150 and AOM 160 are arranged in series between the source 110 and the optical coupler 120.

The polarisation controller ensures that a predetermined state of polarisation is fed to the first optical coupler 120. The first AOM 160 acts as a high-speed switch to turn on and off the light from the source 110. The AOM 160 allows a pulse of a predetermined duration to be fed into the first optical coupler 120.

The pulse then exits the generation stage 180, and enters the first optical coupler 120 at the first port 121. The optical coupler splits the pulse equally, half leaving via the third port 123 and the other half leaving through the fourth port 124. The half leaving through the fourth port 124 is discarded.

The pulse exits the third port 123 and enters the fibre to be located 170. The pulse is reflected at the far end of the fibre to be located 170 by a Faraday mirror 190, having properties as described in more detail below.

The pulse returning from the fibre to be located 170 re-enters the third port 123 of the first optical coupler 120. The pulse exits the second port 122 of the first optical coupler, and enters the detection stage 130.

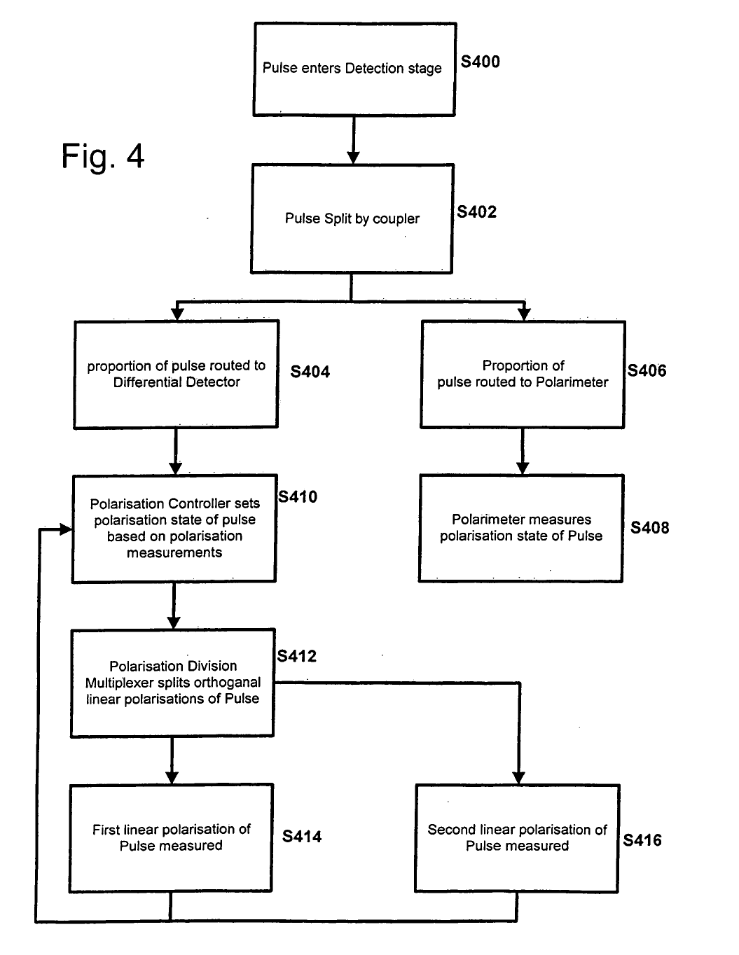

As shown in FIG. 4, the pulse entering the detection stage 130 is input into the second optical coupler 132 at S400. The second optical coupler 132 splits the pulse at S402. From here 90% of the pulse intensity is coupled to the second polarisation controller 134 at S404 and 10% is coupled to the polarimeter 136 at S406.

The polarimeter 136 measures the polarisation state of the pulse as it enters the detection stage 130 at S408. This information is used to calibrate the first polarisation controller 150 for subsequent pulses sent through the apparatus, and to control the second polarisation controller 136 at S410.

The pulse travels through the polarisation controller 134 and the polarisation state of the pulse is adjusted (described below) at S410. The PDM 139 then splits the pulse into two orthogonal linear polarisations at S412. One half of the differential detector 138 receives and detects each of the linear polarisations at S414 and S416.

The polarisation of the pulse detected by the differential detector 138 can be altered by adjusting the polarisation controller 134. FIG. 5 shows the effect of adjusting the linear component of the polarisation of the light on the signal detected by the differential detector 138.

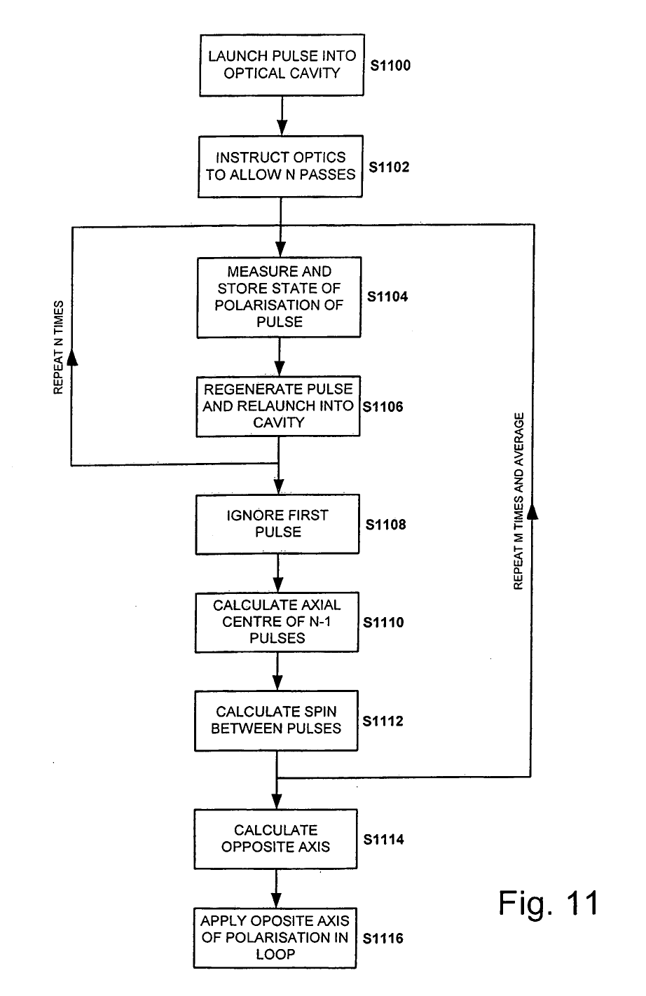

The smallest changes in the polarisation of the pulse can be detected when the gradient of the line charting polarisation angle against voltage in the detector 138 is highest. This occurs when the angle of polarisation of the pulse coming into the differential detector 138 is set at 45° to the differential detector 138. The polarisation controller 134 is therefore adjusted such that this condition is fulfilled using suitable software, the operation of which is described with reference to FIG. 11, below.

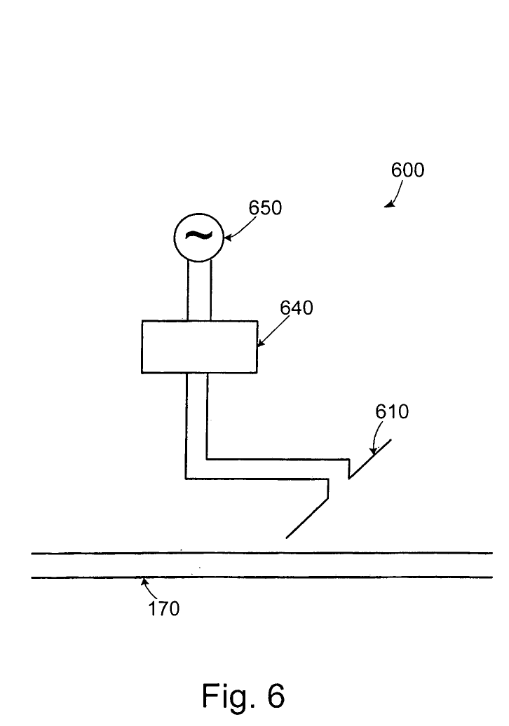

The first embodiment of the invention can detect the location of the fibre-optic cable by the variation in polarisation of the pulse as it is detected. The variation in the pulse is induced, as shown in FIG. 6, by an antenna 600, remote from the detection stage, which applies a modulated field to the fibre to be located 170.

The antenna 600 comprises electric dipole oscillator 610, which produces a magnetic field that is perpendicular to the axis of the dipole along the line of the cable. The dipole 610 is aligned along the axis perpendicular to the fibre to be located 170. A control unit 640 powered by a power supply 650 drives the dipole 610.

Further antennae 620, 630 may also be used; these further antennae are not essential. Where more than one antenna is used, spaced laterally to the cable, this can give more accurate positional results of the location of the cable.

The field produced by the antenna 600 causes a rotation in the linear component of state of polarisation of light in the fibre to be located 170 under the antenna 600 due to the Faraday effect.

The dipole(s) produce(s) a magnetic field, the line integral of which is non-zero along the axis of the cable. This ensures that the overall Faraday effect on light travelling along the cable is non-zero.

However, birefringence within the fibre to be located 170 causes polarisation mode dispersion, where a first state of polarisation propagates along the fibre to be located 170 faster than a second state of polarisation, and circular birefringence, which rotates the polarisation state as the light propagates.

Because of this birefringence, the state of polarisation of the light underneath the antenna will not generally be the same as the state of polarisation entered into the fibre to be located 170. Therefore, successive pulses are input into the fibre to be located 170 from the generation stage 180. Three different orthogonal polarisation states are input into the fibre to be located 170 from the generation stage 180. These states are generated using the polarisation controller 150.

If these three orthogonal states are entered into the fibre to be located 170 sequentially, then one of the states will be at least 67% linearly polarised directly under the antenna 600. This is because if the three states are orthogonal, the worst match with the polarisation under the antenna 600 is that all three states are 45° relative to the magnetic field under the antenna 600, giving a projection of (sqrt.2)/2 onto the axis of the fibre to be located 170.

Assuming that one of the three pulses input into the fibre to be located 170 by the generation stage 180 is suitably linearly polarised under the antenna 600, the angle of polarisation of the pulse travelling along the fibre to be located 170 is rotated by the modulated magnetic field. The extent of the rotation is proportional to the magnetic field applied to the fibre to be located 170.

The closer the antenna is to the fibre to be located 170, the larger the angle of rotation of the polarisation state. If the antenna 600 is off, or sufficiently far away, no rotation occurs due to the antenna 600 and a control reading can be taken. In this way, the location of the fibre to be located 170 can be established by observing the rotation of the polarisation of the light while the antenna is moved. The detector of the embodiment may further provide feedback to the antenna in order to enable a user of the antenna to quickly locate the fibre to be located 170. The feedback may be by radio carrier.

It has already been stated that the Faraday effect is very weak, and it is made weaker by the fact that the magnetic field attenuates between the antenna 600 and the fibre to be located 170.

The pulse of light in the fibre to be located 170 is therefore passed back along the fibre to be located 170, where it is rotated by the magnetic field a second time. It is important that the rotation of the state of polarisation on the return path of the pulse is constructive with the rotation given on the outward path, rather than destructive. The state of polarisation of the pulse changes along the fibre to be located 170. Therefore, a means of ensuring the polarisation state of the pulse as it passes under the antenna 600 on the return path must be used.

The Faraday mirror 190 is used in order to obtain the orthogonal polarisation state at the point the pulse passes the antenna 600 when it is travelling in the opposite direction. Alternatively, any other suitable polarisation conjugate return device may be used instead of a Faraday mirror. The mirror 190 inputs back into the fibre to be located 170 light that is the conjugate of the light it receives. At every point along the fibre to be located 170, the light travelling in one direction is the conjugate of the light travelling in the other. Because of the opposing direction of the outward and return paths, a constructive Faraday effect is achieved as the pulse returns along the return path in the fibre to be located 170.

In order to ensure that the Faraday effect is additive on the second pass, the excitation frequency should be chosen such that the wavefront must be seen by the light propagating in the fibre to have the same phase when passing in both directions.

The detection stage 130 receives a pulse that has twice the rotation applied to it that would have been applied if the detection stage 130 were at the second end of the fibre to be located 170.

In one round trip, the light in the pulse travels twice the optical length of the fibre to be located 170 together with any additional optical length introduced by the Faraday mirror 190 and the polarisation controller and detector. This overall length is called the cavity length.

The allowed magnetic field excitation frequencies that can be used are determined by the cavity length. This is because a standing wave must be set up to ensure that the same phase occurs when travelling in each direction. The cavity length can be determined by simply timing how long it takes for a pulse of light to travel through the optical cavity.

However, the situation is further complicated in that a standing wave solution generates a series of peaks and nulls. In order to be able to detect the cable at every point along its length, there must be frequency diversity in the excitation. The antenna control unit 640 is then tuned to suitable frequencies, which generate standing waves in the optical cavity without substantial nulls.

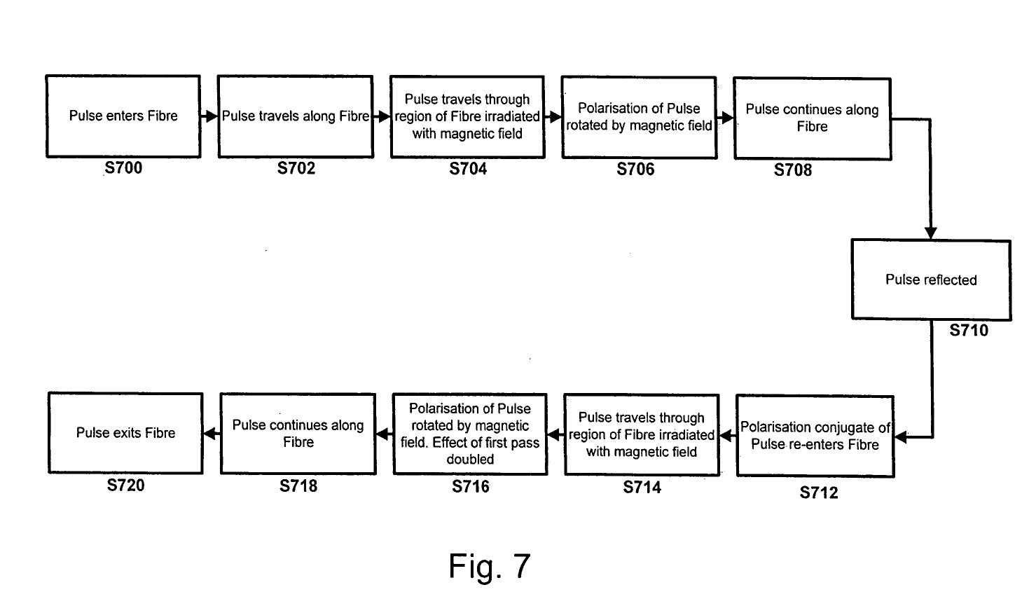

FIG. 7 shows a flow diagram of the pulse travelling through the fibre to be located 170. The pulse enters the fibre to be located 170 at S700, and travels along the fibre to be located at S702. The pulse travels through the magnetic field applied by the antenna 600 at S704 and is rotated at S706. The pulse then continues along the fibre to be located 170 at S708 and is reflected at the far end of the fibre to be located 170 at S710.

The conjugate of the pulse then re-enters the fibre to be located 170 at S712 and travels through the magnetic field for a second time at S714. The Faraday rotation of polarisation is doubled by this at S716 and the pulse continues along the fibre to be located 170 at S718 until it exits the fibre to be located 170 at S720.

A second embodiment of the invention will now be described. The second embodiment is a variation on the first embodiment described above, and like parts will retain the same numbering as in the first embodiment.

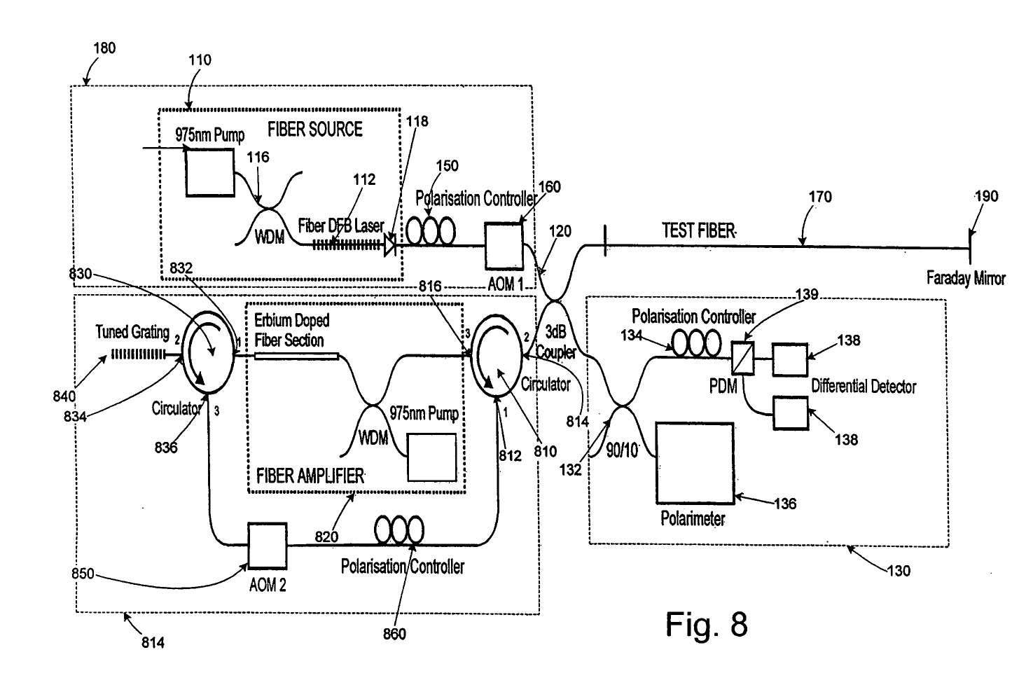

FIG. 8 shows the apparatus of the second embodiment of the invention together with the fibre to be located 170. The generation stage 180 and detection stage 130 of the second embodiment correspond to those of the first embodiment and no further explanation of these will be given.

The detection stage 130 is arranged differently to the first embodiment, in that it is connected to the fourth port 124 of the first optical coupler 120, rather than the second port 122.

A regeneration stage 800 is connected to the first port 121 of the first optical coupler 120 in the second embodiment. The regeneration stage 800 comprises a first circulator 810, a Fibre amplifier 820, a second circulator 830, a tuned grating 840, a second AOM 850 and a third polarisation controller 860.

The first circulator 810 has three ports. The second port 814 connects to the second port 122 of the first optical coupler 120. The third port 816 connects to the fibre amplifier 820, and the first port 812 connects to the third polarisation controller 860.

The fibre amplifier 820 comprises a pump 822 and WDM 824, as in the source 110. Instead of a laser, however, an erbium-doped fibre section 826 is provided. The output of the fibre amplifier is connected to the second circulator 830.

The second circulator 830 has three ports. The first port 832 is connected to the output of the fibre amplifier 820. The second port 834 is connected to the tuned grating 840, and the third port is connected to the second AOM 850.

The AOM 850 is connected in series between the second circulator 830 and the third polarisation controller 860.

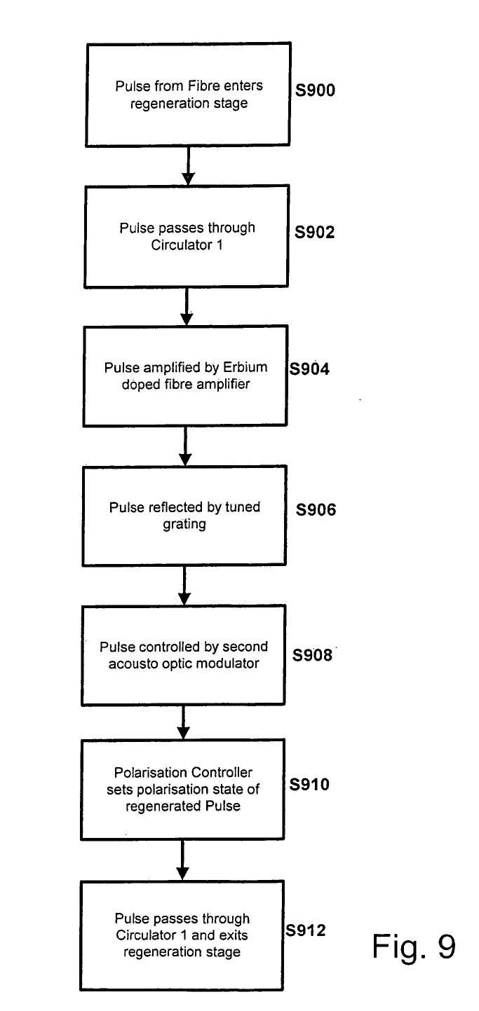

The method of regeneration in the regeneration stage 800 will now be described with reference to FIG. 9.

At S900 the pulse enters the regeneration stage from the fibre to be located 170 via the first optical coupler 120. The pulse travels through the first circulator 810 from the second port 814 to the third port 816 at S902 and enters the fibre amplifier 820. The fibre amplifier amplifies the pulse as it travels through it at S904.

However, the fibre amplifier 820 will also emit undesired broadband spontaneous emission in addition to the amplified signal, which itself is amplified. Therefore, the pulse then enters the first port 832 of the second circulator 830 and exits the second port 834 of the second circulator 830 to the tuned grating 840. The grating 840 is a narrow band fibre grating corresponding to the channel spacing. This grating 840 filters out any undesired amplified spontaneous emission at S906 and reflects the desired signal.

The filtered pulse then re-enters the second port 834 of the second circulator 830 and exits from the third port 836 of the second circulator 830. The pulse can then be stopped at any time by closing the second AOM 850. The polarisation of the pulse can be adjusted by the third polarisation controller 860, before the pulse enters the first port 812 of the first circulator 810, where it is output from the second port 814 of the first circulator 810 back into the first optical coupler 120.

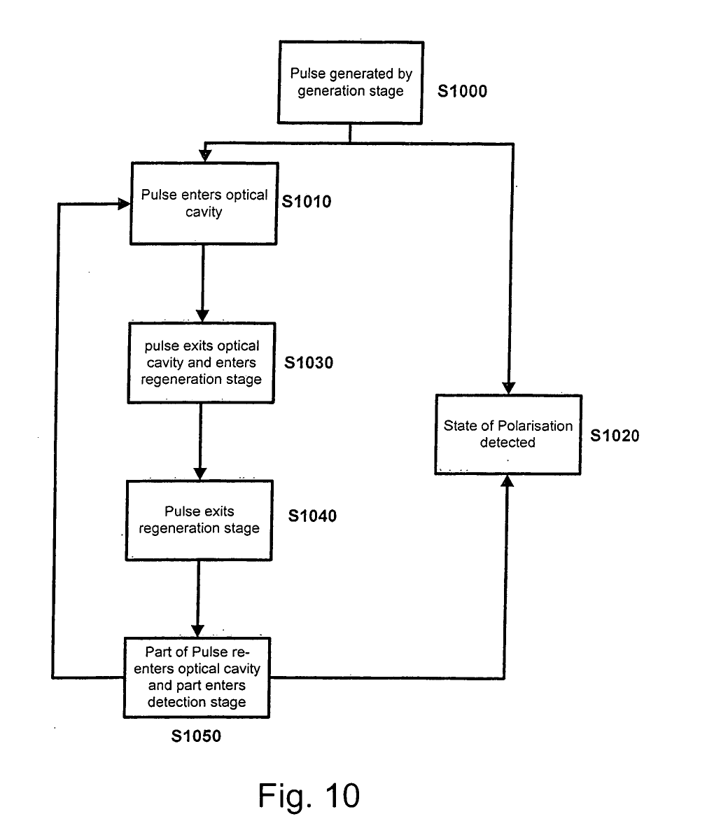

The overall path taken by a pulse of light in the second embodiment will now be described. FIG. 10 shows a flow diagram giving the overall process of the light path.

The pulse is generated at S1000 by the generation stage 180. The pulse is then split by the first optical coupler 120. Half of the pulse enters the fibre to be located 170 at S1010. The other half of the pulse enters the detection stage 130 at S1020.

The pulse that entered the fibre to be located 170 is reflected by the faraday mirror 190 at the far end and exits the fibre to be located 170. This pulse re-enters the first optical coupler 120.

The pulse from the fibre to be located 170 then enters the regeneration stage 800 at S1030. The amplified pulse is returned from the regeneration stage 800 at S1040 and is split by the first optical coupler 120, with half of the amplified pulse re-entering the fibre to be located 170 and the other half entering the detection stage 130 at S1050.

Multiple passes are sent down the fibre to be located 170 in the same way as in the first embodiment, in order to provide different orthogonal polarisation states. However, because of the regeneration stage, the same pulse, with a Faraday effect rotation already introduced, can be re-inputted into the fibre to be located 170. It is therefore possible to obtain much increased rotation of the polarisation state.

However, in order to achieve increased rotation of the polarisation state, the Faraday effect introduced on each pass must be constructive, rather than destructive. Assuming that the fibre to be located 170 has constant properties, this can be done by ensuring that the polarisation state of the pulse is the same every time it enters the fibre to be located 170 as it was the first time it entered.

Therefore, on the first pulse, the polarisation state of the pulse is measured by the polarimeter 136 of the detection stage 130 before it has passed through the fibre to be located 170.

Subsequent passes can then compared with the first pass, and the third polarisation controller 860 can be adjusted, by use of suitable feedback software, so that the regeneration stage 800 acts as a mirror for the pulse such that each time it enters the fibre to be located 170 it does so with the same initial polarisation state and same initial power.

In order to determine a suitable state of polarisation to be applied to pulses input into the cavity, a calibration process is carried out. FIG. 11 shows a flow diagram of the calibration process. A pulse is launched into the optical cavity at S1100. The regeneration stage is configured to allow N passes through the optic system at S1102 in one series.

On each pass through the system, the state of polarisation of the pulse is measured and stored at S1104 before being regenerated and relaunched into the cavity at S1106. S 1104 and S1106 are repeated N times. The first pulse in the series is ignored at S1108.

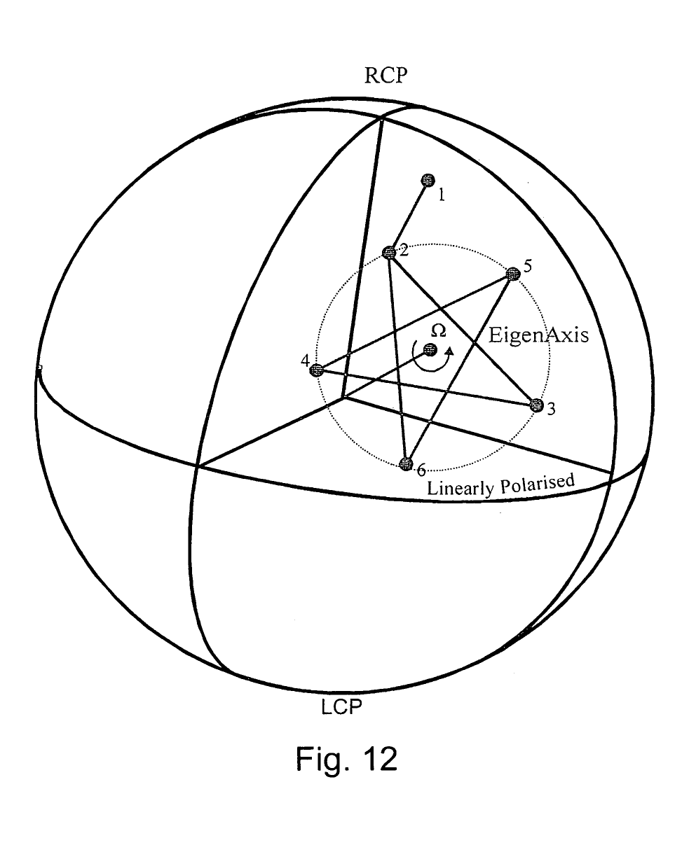

The processor then calculates the axial centre generated by the remaining N-1 pulses, as shown in FIG. 12, at S1110. The processor calculates the spin of the pulses at S1112, and the sequence is then repeated M times, with the spin of the axis recalculated and averaged on each repeat with the previous spins.

The processor then calculates the opposite axis to the averaged axis at S1114, and the opposite axis of polarisation is applied to the pulses re-launched into the cavity at S1116.

FIG. 12 shows a Poincaré Sphere showing the typical polarisations of a successive set of regenerated pulses. The Poincaré Sphere shows all linear polarisations around the equator of the sphere with right handed polarisations in the upper hemisphere and left handed polarisations in the lower hemisphere with full circular polarisation at the poles. The actual polarisation is generally a combination of such orthogonal polarisation states and is at a point on the surface of the sphere. Parts lying within the sphere denote partially polarised light.

Point 1 shows the initial polarisation i.e. the first captured pulse. This polarisation state is determined simply by the first polarisation controller 150 and the birefringence between it and the polarimeter 136.

This state evolves as it travels through the optical cavity and regeneration stage to pulse 2 shown at point 2. Successive regeneration pulses each experience the same evolution and describe a circle on the surface of the Poincaré Sphere (points 3, 4, 5 and 6). The centre of this circle corresponds to the eigen-axis of the fibre to be located 170 and regeneration stage 800.

By measuring the polarisation of this centre and the amount of rotation about it in each successive regeneration pulse it is possible to adjust the third polarisation controller 860, in the regeneration stage 800, to compensate for this birefringence, by adjusting the polarisation controller 860 such that it has the same eigan-axis but with the opposite spin. When this is done, each regeneration pulse entering the fibre to be located 170 will do so with the same polarisation state, so enabling constructive Faraday modulation on each pass.

Although the pulse length is set to be substantially equal to the cavity length, Rayleigh backscattering will give rise to noise. As the pulse propagates along the fibre to be located 170, a small proportion is backscattered. This backscattering is at the same wavelength as the source, and so is amplified in the regeneration stage 800. This, over multiple passes is a substantial source of noise.

This noise can be reduced by reducing the pulse length to half of the cavity length. In this way, some backscattered light can be removed from the cycle by closing the second AOM 850 when the pulse is travelling away from the apparatus, as only backscattered light will be received in this time, and reopening the second AOM 850 in the second half of the cycle, when the pulse is returning from the fibre to be located 170.

The recycling of the pulse can be continued for any number of cycles until the noise becomes too great, or a result is obtained. The second AOM 850 is then closed and the pulse is dumped. A fresh pulse can then be generated by the generation stage and the process started again.

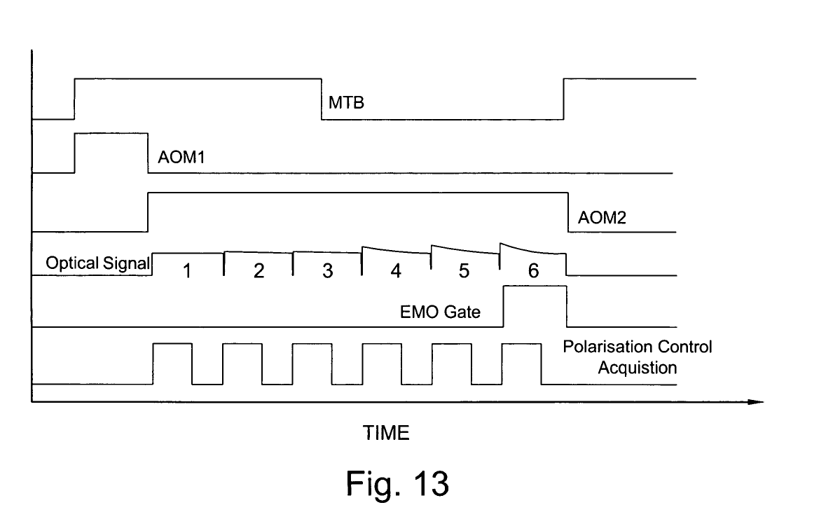

The amplification of the second embodiment will now be described. FIG. 13 shows various timing parameters during successive cycles of pulses through the apparatus and fibre to be located 170.

In order to use the second embodiment of the invention, the pulse is sent through the fibre to be located 170 a predetermined number of times. On the final cycle, the processor processes the rotation of polarisation detected by differential detector 138. The pulse is then removed from the system by closing the second AOM 850 as described above.

A new pulse is then generated by opening the generation stage 180 by opening the first AOM 160 and allowing a pulse with length equal to the cavity length out of the generation stage 180, before re-closing the first AOM 160.

This process is then repeated in order to provide successive results.

In order for the system to operate correctly, the net gain for each cycle of a pulse as it is regenerated and between successive pulses must be set to approximately 1. If a gap is left between pulse regeneration or between successive pulse trains, for example, if the first and second AOMs 160, 850 are both shut for a period, then there will be an impulse in the amplifier gain, due to the time that the pulse was allowed to “charge” in the amplifier during this period. If both AOMs 160, 850 are left open at the same time then lasing will occur.

The timing should therefore be set such that no gaps are left, and no overlap occurs, between regeneration cycles and between successive pulse trains. The amplifier gain can then be controlled by a computer such that the amplitude of the pulses remains constant.

FIG. 13 shows the opening and closing of the first and second AOMs 160, 850.

The first pulse carries no information regarding the fibre to be located 170, as it has not yet travelled down it. However, it contains initial polarisation data. The first regeneration of the pulse carries twice the Faraday modulation, the second regeneration pulse carries four times the Faraday modulation and so on. The pulse is detected by the polarimeter 136 in the first half of every cycle of the pulse along the fibre to be located 170 and back to allow for feedback into the regeneration stage 800.

The pulses have progressively higher initial intensities (which have been exaggerated in the Figure) due to noise increases in successive regeneration pulses.

The detected results from all of the regeneration pulses can be recorded. However, in this embodiment, only the results from the sixth pulse are taken from the differential detector and processed by the processing software. The sixth pulse will carry 10 times the modulation of a single pass. If data from the 100^{th} pass is processed, the modulation carried will be 198 times the modulation from a single pass.

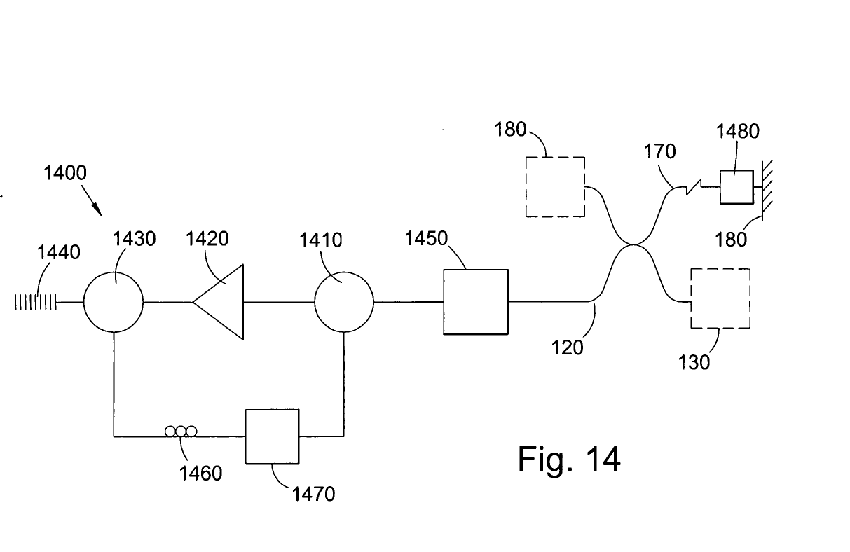

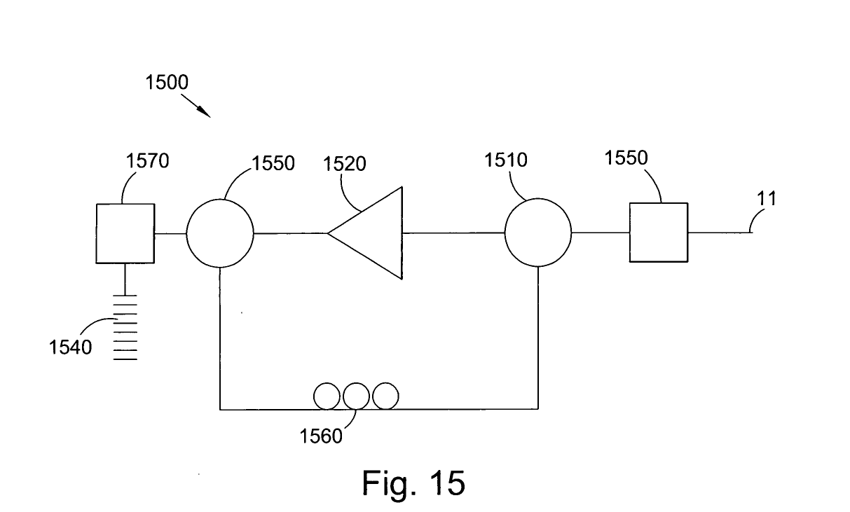

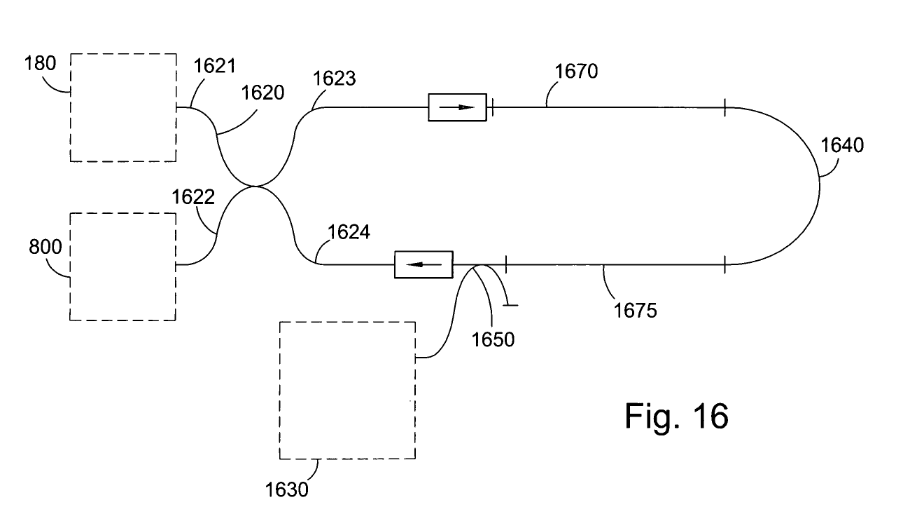

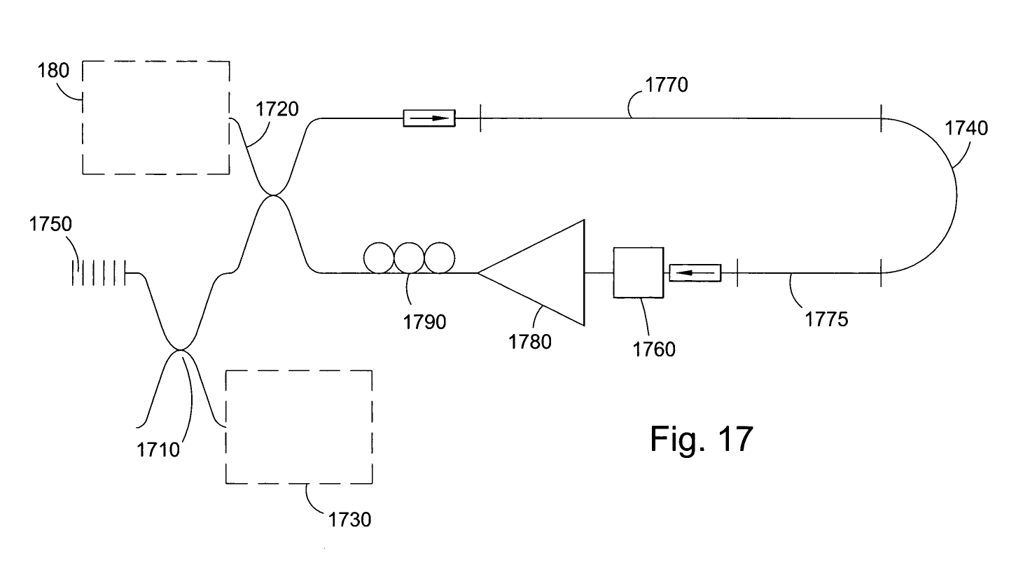

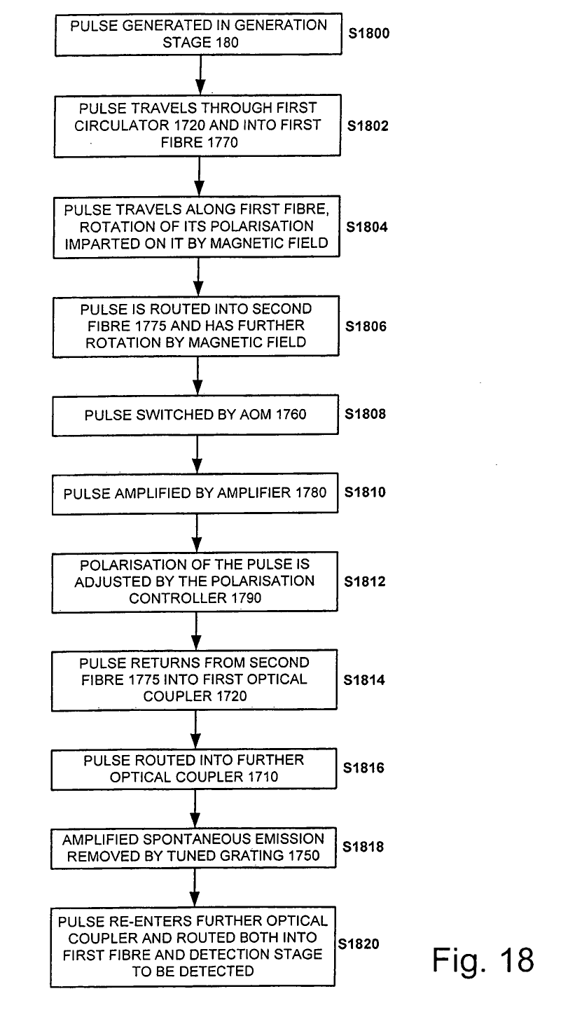

FIG. 14 shows a regeneration stage 1400 according to a third embodiment of the present invention. The other elements of the embodiment are the same as those of the second embodiment and so are not shown. Additionally, a third AOM is placed at the far end of the fibre to be located before the Faraday mirror.

The regeneration stage 1400 of the third embodiment is similar to that of the second embodiment. First circulator 1410, amplifier 1420 (shown only schematically), second circulator 1430, tuned grating 1440 and polarisation controller 1460 all operate in the same way as the corresponding units of the second embodiment.

However, the second AOM 1450 of the regeneration stage is placed between the first optical coupler 120 and the first circulator 1410. A delay loop 1470 is placed between the polarisation controller 1460 and the first circulator 1410. The delay loop 1470 has an optical delay corresponding in length to the optical length of the fibre to be located 170.

The second AOM 1450 selectively allows pulses returning from the fibre to be located into the regeneration stage. The second and third AOMs 1450, 1480 are controlled such that Rayleigh backscatter is reduced by not allowing it to enter the regeneration stage 1400. By selectively opening the second and third AOMs 1450, 1480, Rayleigh backscatter from the pulse as it travels in both directions can be reduced.

FIG. 15 shows an alternative regeneration stage 1500 of a fourth embodiment of the invention. As in the third embodiment, a third AOM is placed at the far end of the fibre to be located 170 before the Faraday mirror 180.

In this embodiment, the delay loop 1570 is placed between the second circulator 1530 and the tuned grating 1540. This configuration provides an advantage that the regeneration stage 1500 is acoustically insensitive.

In all of the above embodiments, the fibre to be located 170 may actually comprise two fibres optically linked at the end distal to the apparatus. The pulses may enter the first fibre and travel to the distal end before being routed into the second fibre to follow a return path back towards the apparatus. The Faraday mirror can then be placed at the second end of the second fibre to reflect the light back to the apparatus through both fibres. An advantage of this is that the pulse travels underneath the antenna a total of four times for each round trip, so doubling the Faraday rotation of the pulse compared with the rotation when the Faraday mirror is simply placed at the far end of a single fibre.

In a fifth embodiment, the above two fibre system is altered so that, instead of using a Faraday mirror at the second end of the second fibre, the second fibre is directly connected to the first optical coupler 1620. Such an embodiment is shown in FIG. 16. The generation stage 180 and the regeneration stage 800 are the same as the second embodiment, and are shown only schematically.

The first fibre 1670 is connected to the first optical coupler 1620 as in previous embodiments. The distal ends of the first and second fibres are optically coupled with an optical link 1640. The detection stage of the second embodiment is moved, and the second fibre 1675 is connected to the first optical coupler 1620 in its place. The detection stage is connected via a third optical coupler 1650. The first optical coupler of the fifth embodiment differs from that of the previous embodiments in that the fourth port 1624, to which is connected the second fibre 1675, does not receive pulses generated by the generation stage 180, but only inputs pulses which have travelled around the fibre loop. This is achieved by modifying the coupler 1620. Alternatively, an optical isolator may be placed between the third optical coupler 1650 and the fourth port 1624 of the first optical coupler 1620.

The detection stage 1630 is the same as the first and second embodiments other than its location, and has been shown only schematically.

FIG. 17 shows a sixth embodiment of the present invention. The sixth embodiment is similar to the fifth embodiment in that two fibres 1770, 1775 are used, and both the first and second fibres are connected to the first optical coupler 120 in order to form a closed loop configuration.

However, in the sixth embodiment, the arrangement of the detection and regeneration stages is different from that of the fifth embodiment. The generation stage 180 is connected to the first port 121 of the first optical coupler. The first fibre 1770 is connected to the third port 1723 of the first optical coupler 1720 and the second fibre is connected to the fourth port 1724, as in the fifth embodiment. A further optical coupler 1710 is connected to the second port of the first optical coupler 1720.

The further optical coupler 1710 has a detection stage 1730 as described in the first and second embodiments connected to it, and is therefore shown only schematically, and also a tuned grating 1750.

The second fibre 1775 is connected to a regeneration stage. The regeneration stage comprises an AOM 1760, an amplifier 1780 and a polarisation controller 1790. The AOM switches to reduce Rayleigh backscattering, as described above. The amplifier is of the same form as the amplifier in the detection stage of the second embodiment, and is therefore shown only schematically. The polarisation controller has the same function as in the second embodiment and will not be described further.

FIG. 18 shows a flow diagram according to the sixth embodiment of the invention.

A pulse is generated in the generation stage 180 at S1800. The pulse travels through the first coupler 1720 and into the first fibre 1770 at S1802. The pulse travels along the first fibre, and has a rotation of its polarisation imparted on it by a magnetic field at S1804. The pulse is routed into the second fibre 1775 and returns along the second fibre 1775 where a further constructive rotation of its polarisation is imparted on it by the magnetic field on its return path at S1806.

The pulse is switched by AOM 1760 at S1808, and amplified by the amplifier 1780 at S1810. The polarisation of the pulse is adjusted by the polarisation controller 1790 at S1812.

The pulse returns from the second fibre 1775 into the first optical coupler 1720 at S1814 and is routed into the further optical coupler 1710 at S1816. The amplified spontaneous emission is removed by the tuned grating 1750 at S1818. The pulse then re-enters the further optical coupler 1710 where it is routed both into the detection stage 1730 to be detected and to re-enter the first fibre 1770 at S1820.

Alternatively, the fifth and sixth embodiments, the two fibres may be in separate cables, which follow differing physical paths. The Faraday rotation is only imparted onto the pulse in the first fibre 1670, 1770 to which is applied the magnetic field and no Faraday rotation is imparted in the second fibre 1675, 1775 to which no magnetic field is applied. In this case a single rotation is imparted in each cycle of the pulse. These embodiments provide multiple Faraday effect rotation.

The present invention has been described purely by way of example and modifications can be made within the spirit of the invention. The invention also consists in any individual features described or implicit herein or shown or implicit in the drawings, or any combination of any such features, or any generalisation of any such features or in combination. Each feature disclosed in the specification, including the abstract, claims, and drawings, may be replaced with an alternative feature or features serving the same, equivalent or similar purpose, unless expressly stated otherwise. For example, differential detector 138 need not be a differential detector. Also, AOMs need not be used; other types of switches may also be used. Those skilled in the art will realize the different possible individual features possible in carrying out the invention and will not be limited to the embodiments described herein.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method of detecting or locating a fibre optic cable comprising an optic fibre, the method comprising:
applying a magnetic field substantially parallel to the cable carrying multiple passes of a polarised beam of radiation to cumulatively rotate the polarisation of the polarised beam of radiation along the cable; and
detecting the cumulative rotation of polarisation of the beam thus caused by said multiple passes.

2. The method as in claim 1, wherein the beam is a pulse.

3. The method as in claim 1, wherein the beam passes along the cable in first and second opposite directions.

4. The method as in claim 3, wherein the beam passes along the same fibre in the first and second directions.

5. The method as in claim 3, wherein the fibre optic cable to be detected comprises a plurality of fibres and the beam passes along a first fibre in the cable when travelling in the first direction, and along a second fibre in the cable when travelling in the second direction.

6. The method as in claim 1, further comprising reflecting the beam at a second end of the cable, such that the polarisation of the beam travelling along the cable in the second direction is, at any point on the cable, the polarisation conjugate of the beam travelling in the first direction.

7. The method as in claim 1, wherein the beam passes along the cable in one direction only.

8. The method as in claim 1, wherein the polarisation of the beam is detected with a polarimeter.

9. The method as in claim 1, wherein a processor selectively processes the detected change in polarization.

10. The method as in claim 1, wherein the beam is caused to re-enter the cable at a first end of the cable and to travel in the first direction, successive re-entries of the beam having the same polarisation.

11. The method as in claim 10, wherein the beam is split in each re-entry cycle, with a proportion of the beam remaining in the re-entry cycle and a proportion of the beam being measured in the detection stage.

12. The method as in claim 10, wherein the detected polarisation is used to adjust the polarisation of the beam exiting the re-entry cycle.

13. The method as in claim 10, wherein the beam is amplified and re-enters the cable, such that the net gain of successive beams entering the cable is substantially one.

14. The method as in claim 1, wherein a plurality of beams having different polarisations are generated and successively input into the cable.

15. The method as in claim 1, wherein an antenna is used to generate the electromagnetic field, which is applied to the fibre-optic cable in a direction substantially parallel to the fibre-optic cable and causes said rotation of polarisation of the beam in the cable.

16. An apparatus for use in locating or detecting a fibre optic cable comprising at least one cable fibre, to which a magnetic field substantially parallel to the cable has been applied, and through which a polarised beam has made multiple passes, the polarisation of the beam having been cumulatively rotated on each pass, the apparatus comprising:
detecting means to detect the cumulative rotation of polarisation of the beam caused by the effect of the magnetic field on the beam on the multiple passes.

17. The method as in claim 16, further comprising input means for inputting the beam into a first end of the cable.

18. The method as in claim 16, wherein the detecting means is arranged to detect the cumulative rotation of polarisation of the beam at a first end of the cable.

19. The method as in claim 17, wherein the input means are arranged to input the beam into a first fibre of the cable.

20. The method as in claim 19, wherein the detecting means are arranged to detect the beam from the first fibre of the cable.

21. The method as in claim 17, further comprising polarisation conjugate reflecting means for reflecting the beam, as a polarisation conjugate, at a second end of the cable.

22. The method as in claim 16, wherein the input means are arranged to input the beam into a second cable optically connected to the cable.

23. The method as in claim 16, wherein the detecting means is arranged to detect the cumulative rotation of polarisation of the beam at a first end of a second cable optically connected to the cable.

24. The method as in claim 16, wherein the detecting means comprises a differential detector.

25. The method as in claim 16, wherein the detecting means comprises a polarisation detector.

26. The method as in claim 16, wherein the detection means comprises differential detection means for detecting the difference in intensity between two orthogonal polarisations of the beam.

27. The method as in claim 16, wherein the detecting means is arranged to output a signal representative of the detected cumulative polarisation, and the apparatus further comprises processing means for selectively processing the output from the detecting means.

28. The method as in claim 16, further comprising beam amplifying means for receiving the beam after passing along the cable and causing the beam to re-enter the cable with the same polarisation as a previous entry of the beam into the cable.

29. The method as in claim 28, wherein the beam amplifying means is arranged to cause a portion of the beam to re-enter the cable, and to cause a portion of the beam to be detected by the detecting means.

30. The method as in claim 27, wherein the beam amplifying means comprises a polarisation controller to adjust the polarisation of the beam exiting the amplifier.

31. The method as in claim 30, wherein the detecting means are arranged to provide feedback to the polarisation controller to adjust the polarisation of the beam exiting the amplifier.

32. The method as in claim 27, wherein the beam amplifying means comprises a regeneration stage, the regeneration stage comprising an input, to receive the beam after it has passed along the cable, an amplifier to cause the beam to be regenerated to a predetermined intensity, and an output to cause the beam to re-enter the cable.

33. The method as in claim 16, further comprising light generating means for generating the beam.

34. The method as in claim 33, wherein the light generation means is for generating a beam having a pulse of a duration corresponding to the time required for the pulse to travel from the generation means to the detection means.

35. The method as in claim 32, wherein the generation means is for generating a plurality of beams having differing polarisations to be input successively into the cable.

36. The method as in claim 28, further comprising beam splitting means for splitting the beam re-entering the cable such that a proportion of the beam re-enters the cable and a proportion of the beam is measured in the detection means.

37. A fibre-optic cable location apparatus comprising:
a light input stage, to input a polarised beam of light into the cable;
a regeneration stage, to receive the beam emerging from the cable, and to cause the beam to be amplified and re-enter the cable, with a predetermined amplification, re-entries of the beam having the same polarisation; and
a detection stage to detect a variation in polarisation of the polarised beam caused by rotation of the polarisation by application of a magnetic field substantially parallel to the cable.

38. The method as in claim 38, wherein the light generation stage and regeneration stage are arranged to input and receive a beam into and from the same cable respectively.

39. The method as in claim 39 wherein the light generation stage and regeneration stage are arranged to input and receive a beam into and from the same cable fibre within the cable respectively.

40. The method as in claim 38, wherein the detector is arranged to detect a cumulative rotation of polarisation of the beam caused by multiple passes of the beam through the magnetic field.

41. A fibre-optic cable location system comprising:
a magnetic field generator to apply a magnetic field to the cable with a component parallel to the cable and thereby rotate the polarisation of the beam passing through the cable on multiple passes along the cable; and
a detector to detect the cumulative rotation of the polarisation of the beam caused by multiple rotations of the polarisation of the beam during multiple passes of the beam along the cable.

42. The method as in claim 42, further comprising an input to input the beam of polarised radiation into the cable.

43. The method as in claim 42, further comprising a polarisation conjugate mirror arranged to reflect the polarisation conjugate of the beam back into an end of the cable when the beam emerges from the said end of the cable.

44. The method as in claim 42, wherein the magnetic field generator is adapted to receive feedback signals from the detector to control the magnetic field.

45. The method as in claim 42, wherein the magnetic field generator is adapted to receive signals indicative of the relative positions of the field generator and a fibre optic cable to be located.
